(19) United States
(12) Patent Application Publication
(10) Pub. No.: US 2016/0034575 A1
(43) Pub. Date: Feb. 4, 2016

(54) VOCABULARY-EFFECTED E-CONTENT DISCOVERY

(71) Applicant: Kobo Inc., Toronto (CA)

(72) Inventor: Benjamin Landau, Toronto (CA)

(21) Appl. No.: 14/446,055

(22) Filed: Jul. 29, 2014

(51) Int. Cl. G06F 17/30; G06F 3/0483

(52) U.S. Cl. CPC G06F 17/30864; G06F 17/3053; G06F 17/30011; G06F 3/0483

(57) ABSTRACT

A computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input corresponding with a selection of a word or phrase in the displayed content. In response to the first user input, the processor searches an e-book library for e-books containing the selected word or phrase and presents a set of search results on the display assembly. The set of search results includes one or more e-books that contain the selected word or phrase.

### TECHNICAL FIELD

Examples described herein relate to a computing device that provides additional e-book content to a user based on a word or phrase contained in an e-book being read by the user.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reading device or other electronic personal display device, for use with one or more embodiments described herein.

FIGS. 3A-3B illustrate embodiments of an e-reading device that responds to user input by searching an e-book library for e-book content containing a word or phrase associated with the user input.

FIG. 4 illustrates an e-reading system for displaying e-book content, according to one or more embodiments.

FIG. 5 illustrates a method of providing additional e-book content to a user based on a word or phrase contained in an e-book being read by the user, according to one or more embodiments.

### DETAILED DESCRIPTION

Embodiments described herein provide for a computing device that provides additional e-book content to a user based on a word or phrase contained in an e-book being read by the user. The user may select the word or phrase from e-book content displayed on the computing device, for example, by interacting with one or more touch sensors provided with a display assembly of the computing device. The computing device may then search an e-book library for content from other e-books containing the selected word or phrase.

According to some embodiments, a computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input corresponding with a selection of a word or phrase in the displayed content. The selected word or phrase may comprise a string of one or more characters or symbols. For example, the selected word or phrase may include mathematical (or scientific) symbols and/or equations. In response to the first user input, the processor searches an e-book library for e-books containing the selected word or phrase and presents a set of search results on the display assembly. Specifically, the set of search results includes one or more e-books that contain the selected word or phrase.

For some embodiments, the processor may display a visual representation of each of the one or more books from the set of search results. For other embodiments, the processor may display one or more sentences of e-book content from each of the one or more e-books from the set of search results. For example, at least one of the one or more sentences from each e-book may contain the selected word or phrase. Still further, for some embodiments, the processor may display a paragraph of e-book content from each of the one or more e-books from the set of search results. For example, at least one sentence in each paragraph may contain the selected word or phrase.

The processor may filter or sort the set of search results, for example, based on a user preference. For example, the set of search results may be filtered and/or sorted by genre, popularity, reviews, and/or publication date. Alternatively, and/or in addition, the set of search results may be filtered based on a number of instances of the selected word or phrase in each of the one or more e-books. Still further, the set of search results may be filtered based on a sentence length associated with each instance of the selected word or phrase contained in each of the one or more e-books. For some embodiments, the processor may also enable a user to purchase the one or more e-books from the set of search results.

Among other benefits, examples described herein provide an enhanced reading experience to users of e-reader devices (or similar computing devices that operate as e-reading devices). For example, the proper usage and meaning of a particular word is often best understood when that word is used in a sentence or paragraph. More specifically, the sentence and/or surrounding sentences provide literary context for the word that a dictionary may be unable to provide. Thus, by providing additional e-book content to a user based on a search term identified from an e-book that is currently being read, the examples described herein may help a user expand his/her vocabulary while reading content that he or she enjoys.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic. As used herein, the terms “scroll” or “scrolling” refer to a particular method of updating the content and/or state of a display such that the content is perceived to be moving (e.g., upward or downward) across the display. Moreover, the term “obfuscating” may refer to any method of rendering content illegible or difficult to view.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

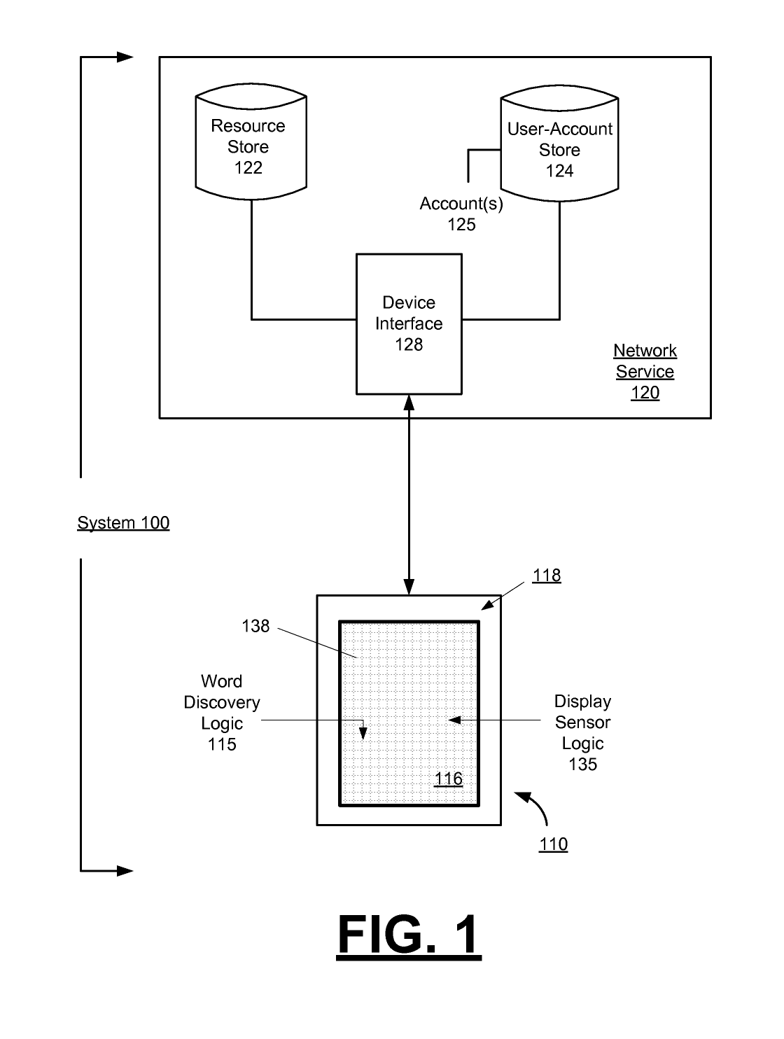

FIG. 1 illustrates a system 100 for utilizing applications and providing e-book services on a computing device, according to an embodiment. In an example of FIG. 1, system 100 includes an electronic display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118.

According to some embodiments, the e-reading device 110 includes display sensor logic 135 to detect and interpret user input made through interaction with the touch sensors 138. By way of example, the display sensor logic 135 can detect a user making contact with the touch sensing region of the display 116. For some embodiments, the display sensor logic 135 may interpret the user contact as a type of user input corresponding with the selection of a particular word or phrase from the e-book content provided on the display 116. For example, the selected word or phrase may coincide with a touch sensing region of the display 116 formed by one or more of the touch sensors 138. The user input may correspond to, for example, a tap-and-hold input, a double-tap input, or a tap-and-drag input.

In some embodiments, the e-reading device 110 includes features for providing functionality related to displaying e-book content. For example, the e-reading device can include word discovery logic 115, which provides additional e-book content to the user based on a word or phrase contained in an e-book being read by the user. Upon detecting a user input corresponding with the selection of a particular word or phrase, the word discovery logic 115 may search an e-book library for other e-books containing the selected word or phrase. Specifically, the word discovery logic 115 may send a search request to the network service 120 to retrieve additional e-book content associated with the selected word or phrase. The word discovery logic 115 may then display a set of search results on the display 116. For example, the set of search results may include a visual representation of one or more e-books containing the selected word or phrase and/or one or more sentences from each of the one or more e-books (e.g., wherein at least one of the sentences from each e-book contains the selected word or phrase). This allows the user to explore additional and/or alternative uses of the selected word or phrase to help better understand the meaning behind that word or phrase.

The word discovery logic 115 can be responsive to various kinds of interfaces and actions in order to enable searching of e-book content. In one implementation, a user can select a particular word or phrase to be searched by interacting with the touch sensing region of the display 116. For example, the user can select a particular word by tapping and holding (or double tapping) a region of the display 116 coinciding with that word. Further, the user can select a phrase by tapping a region of the display 116 coinciding with the beginning of the phrase and, without releasing contact with the display surface, dragging the user's finger to another region of the display 116 coinciding with the end of the phrase.

Hardware Description

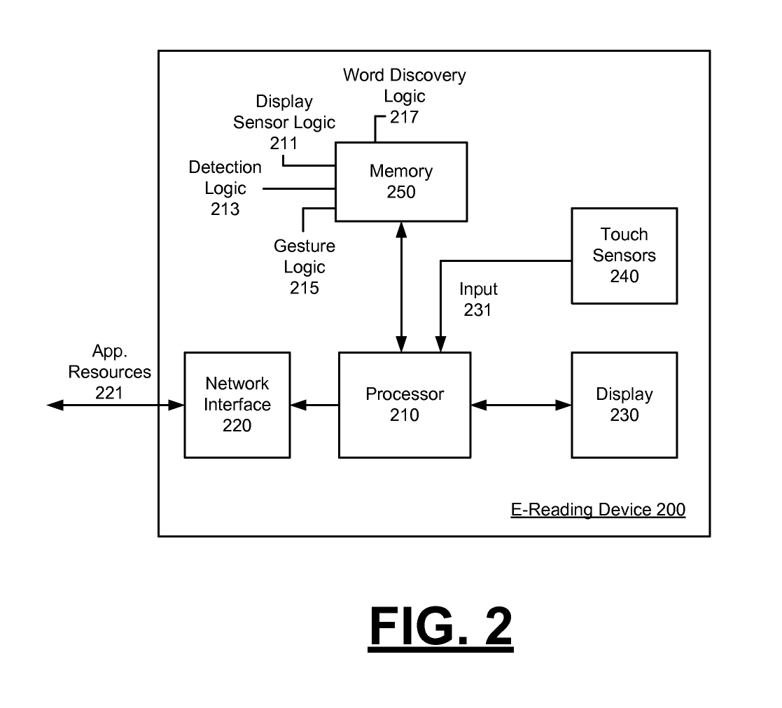

FIG. 2 illustrates an example of an e-reading device 200 or other electronic personal display device, for use with one or more embodiments described herein. In an example of FIG. 2, an e-reading device 200 can correspond to, for example, the device 110 as described above with respect to FIG. 1. With reference to FIG. 2, e-reading device 200 includes a processor 210, a network interface 220, a display 230, one or more touch sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources 221, such as e-books or media files, that the user elects to purchase or otherwise download from the network service 120. The application resources 221 that are downloaded onto the e-reading device 200 can be stored in the memory 250.

In some implementations, the display 230 can correspond to, for example, a liquid crystal display (LCD), an electrophoretic display (EPD), or a light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as generating e-book content on the display 230, performing page transitions of the e-book content, powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. In an alternative embodiment, the display sensor logic 211 may be integrated with the touch sensor components 240. For example, the touch sensor components 240 can be provided as a modular component that includes integrated circuits or other hardware logic, and such resources can provide some or all of the display sensor logic 211 (see also display sensor logic 135 of FIG. 1). For example, integrated circuits of the touch sensor components 240 can monitor for touch input and/or process the touch input as being of a particular kind. In variations, some or all of the display sensor logic 211 may be implemented with the processor 210 (which utilizes instructions stored in the memory 250), or with an alternative processing resource.

In one implementation, the display sensor logic 211 includes detection logic 213 and gesture logic 215. The detection logic 213 implements operations to monitor for the user contacting a surface of the display 230 coinciding with a placement of one or more touch sensor components 240. The gesture logic 215 detects and correlates a particular gesture (e.g., pinching, swiping, tapping, etc.) as a particular type of input or user action. In some embodiments, the gesture logic 215 may associate the user input with a word or phrase from the e-book content coinciding with a particular touch sensing region of the display 230. For example, the gesture logic 215 may associate a tapping input (e.g., tap-and-hold or double-tap) with a word coinciding with the touch sensing region being tapped. Alternatively, and/or in addition, the gesture logic 215 may associate a tap-and-drag input with a phrase swiped over by the user. It should be noted that the word or phrase associated with the user input may comprise any string of characters and/or symbols. For example, the word or phrase may include mathematical and/or scientific symbols or equations.

The memory 250 further stores word discovery logic 217 to provide additional e-book content to the user based on the word or phrase associated with the user input. For example, the user input (e.g., a “word discovery input”) may correspond with the selection of a particular word or phrase from an e-book being read by the user. Upon detecting the user input, the word discovery logic 217 may search an e-book library for other e-books containing the selected word or phrase. For some embodiments, the word discovery logic 217 may send a search request to a network service (e.g., network service 120) using the selected word or phrase as a search term. For other embodiments, the word discovery logic 217 may search a local e-book library (e.g., residing on the e-reading device 200) for the selected word or phrase. For example, the local e-book library may correspond to a cached copy of an e-book library stored on the network service.

The e-reading device 200 may subsequently receive (and/or generate) a set of matching e-book content. For example, the matching e-book content may include one or more sentences (and/or paragraphs) from other e-books that contain the selected word or phrase. The word discovery logic 217 may generate a set of search results including one or more sentences from the matching e-book content to be displayed to the user. For example, the set of search results may include at least one sentence containing the selected word or phrase from each matching e-book. The search results may also include a visual representation of each matching e-book (e.g., to identify the sources of the one or more sentences to the user).

For some embodiments, the word discovery logic 217 may enable a user to filter, sort, or otherwise customize the set of search results. For example, the user may filter the results by genre (e.g., only display e-books pertaining to a particular genre or genres), number of matches (e.g., only display e-books with a threshold number of instances of the selected word or phrase), and/or sentence length (e.g., only display sentences with a threshold number of words). The user may also sort the results by popularity (e.g., display more popular e-books first or more prominently), reviews (e.g., display well-reviewed e-books first or more prominently), and/or publication date (e.g., display newer e-books first or more prominently). Still further, for some embodiments, the word discovery logic 217 may enable a user to purchase an e-book from the set of search results.

Content-Based Word Discovery

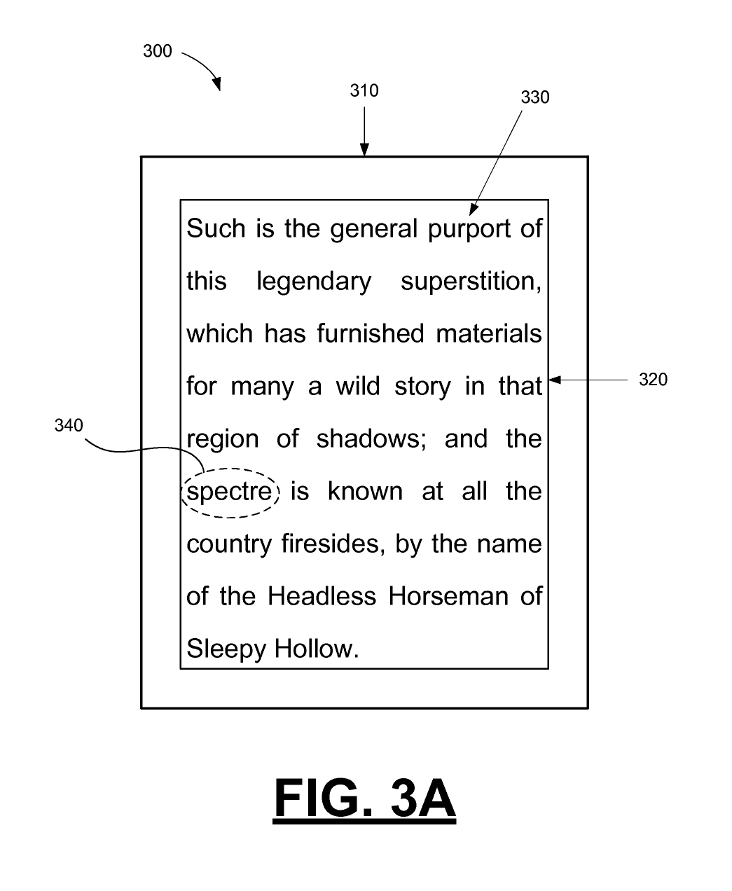

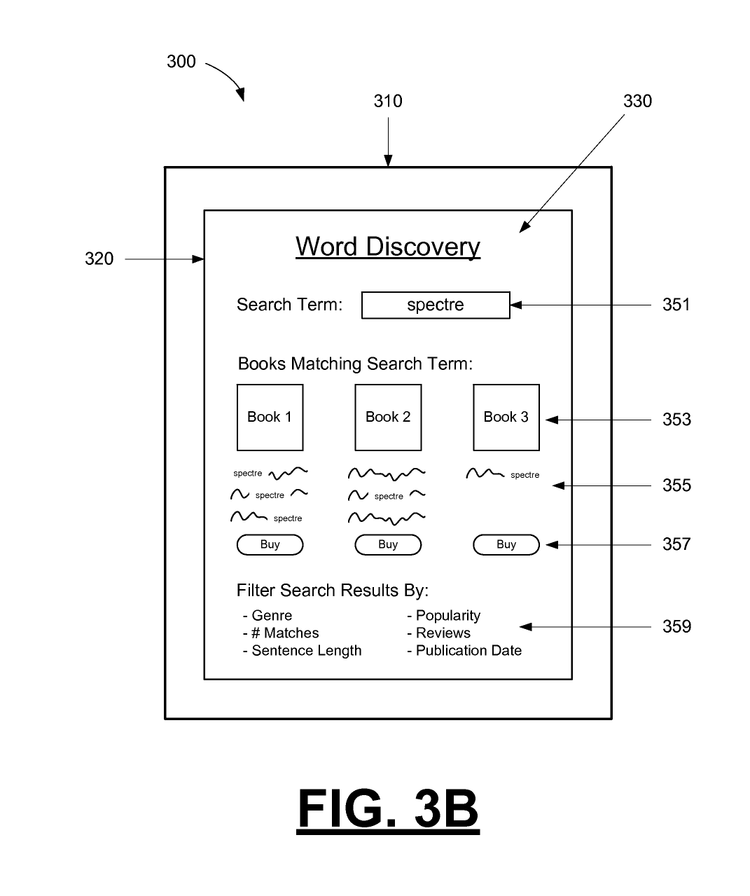

FIGS. 3A-3B illustrate embodiments of an e-reading device that responds to user input by searching an e-book library for e-book content containing a word or phrase associated with the user input. The e-reading device 300 includes a housing 310 and a display screen 320. The e-reading device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the display screen 320. Specifically, the touch sensing region 330 may coincide with the integration of touch sensors with the display screen 320. For some embodiments, the touch sensing region 330 may substantially encompass a surface of the display screen 320. Further, the e-reading device 300 can integrate one or more types of touch-sensitive technologies in order to provide touch sensitivity on the touch sensing region 330 of the display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

With reference to FIG. 3A, e-book content pertaining to an “active” e-book (e.g., an e-book that the user is currently reading) is displayed on the display screen 320. For some embodiments, the e-reading device 300 may respond to user input received via the touch sensing region 330 by searching for additional e-book content based on a word or phrase associated with the user input. For example, a user may select the word “spectre” by tapping-and-holding (or double-tapping) a region of the display 320 corresponding with that word. The e-reading device 300 may interpret this user input as a word discovery input 340. More specifically, upon detecting the word discovery input 340, the e-reading device 300 may search an e-book library (e.g., in the network service 120) for other e-books containing the word “spectre.” For some embodiments, the e-reading device 300 may respond to word discovery input 340 by first prompting the user (e.g., via a pop-up window) to confirm that he or she would like to search for additional e-books containing the selected word.

The e-reading device 300 may subsequently display a word discovery page (or window) with a set of search results (e.g., as shown in FIG. 3B). For example, with respect to FIG. 3B, the word discovery page may display the user's search term 351 (e.g., “spectre”), a visual representation 353 of one or more e-books (e.g., Book 1, Book 2, and Book 3) that contain instances of the search term, and one or more matching sentences 355 from each e-book. The word discovery page may also enable a user to purchase an e-book (e.g., Books 1-3) from the set of search results, for example, by tapping the “Buy” icon 357 below that e-book. For some embodiments, the user may perform a new search, for example, by tapping the displayed search term 351 and inputting a new search term (e.g., using a virtual or external keyboard). The visual representation 353 of each e-book may include, for example, cover art for that particular e-book.

The matching sentences 355 correspond to one or more sentences from each e-book (e.g., Books 1-3) that contain the search term (e.g., “spectre”). For example, with reference to FIG. 3B, it may be assumed that each line of the matching sentences 355 corresponds with a different sentence. For some embodiments, the matching sentences 355 may include only sentences containing the actual search term (e.g., as shown with respect to Book 1). For other embodiments, the matching sentences 355 may include a paragraph that contains the search term (e.g., as shown with respect to Book 2). For example, the matching sentences 355 may include one or more sentences that do not contain the search term itself, but rather provide additional context for the search term. Still further, for some embodiments, the matching sentences 355 may include only one sentence from each e-book (e.g., as shown with respect to Book 3). For example, reducing the number of sentences shown for each e-book may allow more e-books to be displayed on the word discovery page. This allows for a greater variety of content to help with the user's understanding of the search term.

The word discovery page may also include a filtering menu 359 to allow the user to filter and/or sort the set of search results by different criteria. For example, the user may filter the results by genre (e.g., only display e-books pertaining to a particular genre or genres), number of matches (e.g., only display e-books with a threshold number of instances of the selected word or phrase), and/or sentence length (e.g., only display sentences with a threshold number of words). The user may also sort the results by popularity (e.g., display more popular e-books first or more prominently), reviews (e.g., display well-reviewed e-books first or more prominently), and/or publication date (e.g., display newer e-books first or more prominently). For some embodiments, a user may tap on a particular category to activate a pull-down menu for additional options pertaining to that category. For example, tapping on the “genre” category may cause a list of book genres (e.g., action, crime, drama, fantasy, horror, romance, sci-fi, suspense, etc.) to be displayed. The user may then filter the search results by selecting and/or unselecting one or more of the genres.

It should be noted that, the layout and content of the word discovery page of FIG. 3B have been described for exemplary purposes only. In certain implementations, the word discovery page may include fewer or more features than those shown in FIG. 3B. For example, in some embodiments, the word discovery page may display only the matching sentences 355 from each book.

Word Discovery Functionality

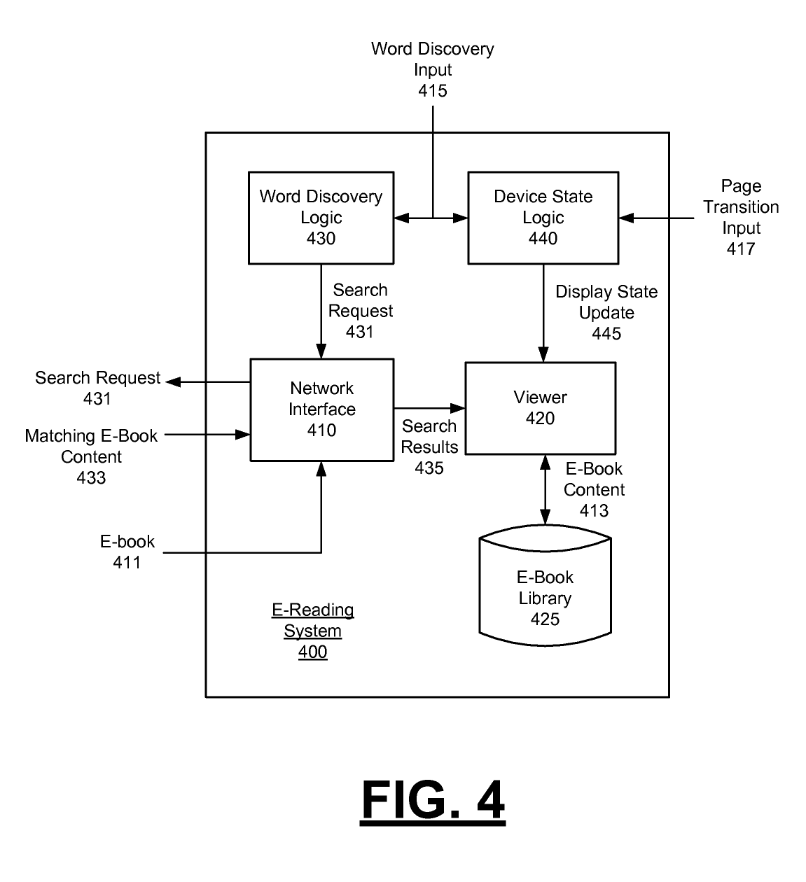

FIG. 4 illustrates an e-reading system 400 for displaying e-book content, according to one or more embodiments. An e-reading system 400 can be implemented as, for example, an application or device, using components that execute on, for example, an e-reading device such as shown with examples of FIGS. 1, 2 and 3A-3B. Furthermore, an e-reading system 400 such as described can be implemented in a context such as shown by FIG. 1, and configured as described by an example of FIG. 2 and FIGS. 3A-3B.

In an example of FIG. 4, a system 400 includes a network interface 410, a viewer 420, word discovery logic 430, and device state logic 440. As described with an example of FIG. 1, the network interface 410 can correspond to a programmatic component that communicates with a network service in order to receive data and programmatic resources. For example, the network interface 410 can receive an e-book 411 from the network service that the user purchases and/or downloads. E-books 411 can be stored as part of an e-book library 425 with memory resources of an e-reading device (e.g., see memory 250 of e-reading device 200).

The viewer 420 can access e-book content 413 from a selected e-book, provided with the e-book library 425. The e-book content 413 can correspond to one or more pages that comprise the selected e-book. Additionally, the e-book content 413 may correspond to portions of (e.g., selected sentences from) one or more pages of the selected e-book. The viewer 420 renders the e-book content 413 on a display screen at a given instance, based on a display state of the device 400. The display state rendered by the viewer 420 can correspond to a particular page, set of pages, or portions of one or more pages of the selected e-book that are displayed at a given moment.

The word discovery logic 430 can retrieve additional e-book content (e.g., from the network service 120 of FIG. 1) in response to receiving a word discovery input 415 associated with a particular word or phrase to be searched. For example, the word discovery input 415 may be provided by the user tapping on a region of a display of the e-reading system 400 that coincides with the identified word or phrase. The word discovery logic 430 may generate a search request 431 based on the word or phrase associated with the word discovery input 415. For example, the search request 431 may include a search term (e.g., the word or phrase associated with the word discovery input 415) and a set of instructions and/or guidelines for generating a set of search results. The search request 431 is then sent (e.g., through the network interface 410) to an e-book library (e.g., residing on the network service 120 of FIG. 1).

The network interface 410 may receive a set of matching e-book content 433 in response to the search request 431, and generate a set of search results 435 (e.g., based on the search request 431) to be sent to the viewer 420. More specifically, the set of search results 435 may include any information needed to generate a word discovery page (e.g., as shown in FIG. 3B). For example, the set of search results 435 may include text from at least one sentence containing the selected word or phrase from each e-book identified by the set of matching e-book content 433. The search results 435 may also include a visual representation of each e-book identified by the set of matching e-book content 433.

The device state logic 440 can be provided as a feature or functionality of the viewer 420. Alternatively, the device state logic 440 can be provided as a plug-in or as independent functionality from the viewer 420. The device state logic 440 can signal display state updates 445 to the viewer 420. The display state update 445 can cause the viewer 420 to change or after its current display state. For example, the device state logic 440 may be responsive to page transition inputs 417 by signaling display state updates 445 corresponding to page transitions (e.g., single page transition, mufti-page transition, or chapter transition).

For some embodiments, the device state logic 440 may also be responsive to a word discovery input 415 by signaling a display state update 445 corresponding to a word discovery page (e.g., as shown in FIG. 3B). For example, upon detecting a word discovery input 415, the device state logic 440 may signal a display state update 445 causing the viewer 420 to display the search results 435 to the user. More specifically, the search results 435 may be formatted and/or otherwise presented as a word discovery page (e.g., as shown in FIG. 3B). For some embodiments, the device state logic 440 may signal additional display state updates 445 to filter and/or sort the search results 435 displayed by the viewer 420 (e.g., in response to user inputs).

Methodology

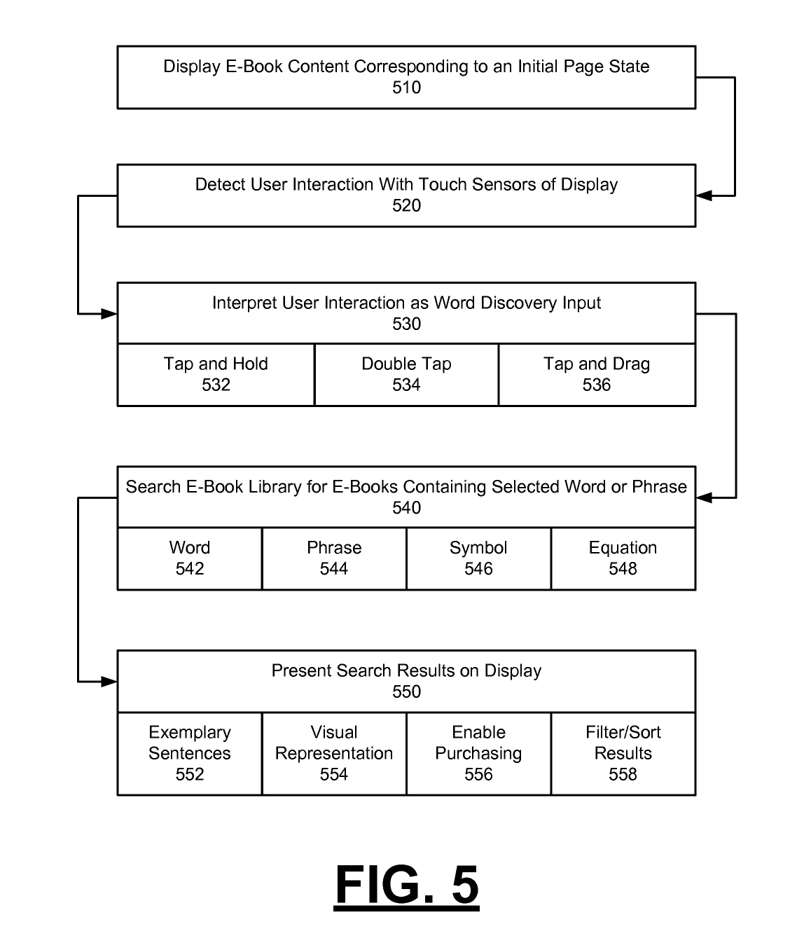

FIG. 5 illustrates a method of continuously scrolling e-book content, according to one or more embodiments. In describing an example of FIG. 5, reference may be made to components such as described with FIGS. 2 and 3A-3B for purposes of illustrating suitable components for performing a step or sub-step being described.

With reference to an example of FIG. 2, the e-reading device 200 may first display e-book content corresponding to an initial display state (510). For example, the device 200 may display a single page (or portions of multiple pages) of an e-book corresponding to the content being read by the user. Alternatively, the device 200 may display multiple pages side-by-side to reflect a display mode preference of the user. The e-reading device 200 may then detect a user interaction with one or more touch sensors provided (or otherwise associated) with the display 230 (520). For example, the processor 210 can receive inputs 231 from the touch sensor components 240.

The e-reading device 200 may interpret the user interaction as a word discovery input (530). More specifically, the processor 210, in executing the word discovery logic 217, may associate the user interaction with a selection of a particular word or phrase provided on the display 230. For some embodiments, the processor 210 may interpret a tap-and-hold input (532) as a word discovery input associated with a word coinciding with a touch sensing region of the display 230 being held. For other embodiments, the processor 210 may interpret a double-tap input (534) as a word discovery input associated with a word coinciding with a touch sensing region of the display 230 being tapped. Still further, for some embodiments, the processor 210 may interpret a tap-and-drag input (536) as a word discovery input associated with a phrase coinciding with one or more touch sensing regions of the display 230 being swiped.

The e-reading device 200 may then search an e-book library for one or more e-books containing the selected word or phrase (540). For example, the processor 210, in executing the word discovery logic 217, may send a search request to a network service (e.g., network service 120 of FIG. 1) specifying the selected word or phrase as a search term to be used to search an e-book library residing on or otherwise stored by the network service. Alternatively, and/or in addition, the processor 210 may use the search term to search a local e-book library (e.g., corresponding to a cached copy of the e-book library residing on network servicer) for e-books containing the selected word or phrase. The search term may comprise any string of characters and/or symbols including, for example, a word (542), a phrase (544), a mathematical or scientific symbol (546), and/or a mathematical or scientific equation (548).

Finally, the e-reading device 200 may display a set of search results to the user (550). For example, the set of search results may content e-book content from one or more e-books matching the search term. More specifically, the search results may include at least one sentence containing the selected word or phrase from each matching e-book. The search results may include one or more sentences and/or paragraphs from each e-book containing the selected word or phrase (552). Additionally, the search results may include a visual representation of each matching e-book (554). For some embodiments, the processor 210, in executing the word discovery logic 217, may enable the user to purchase one or more e-books from the set of search results (556). Further, for some embodiments, the processor 210, in executing the word discovery logic 217 may also enable the user to filter and/or sort the set of search results based on a predetermined set of criteria (e.g., genre, number of matches, sentence length, popularity, reviews, and/or publication date) desired by the user (558).

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a set of touch sensors provided with the display assembly; and
a processor provided within the housing, the processor operating to:
display content pertaining to an e-book on the screen of the display assembly;
detect a first user interaction with the set of touch sensors;
interpret the first user interaction as a first user input corresponding with a selection of a word or phrase in the displayed content;
in response to the first user input, search an e-book library for e-books containing the selected word or phrase; and
present a set of search results on the display assembly, wherein the set of search results includes one or more e-books that contain the selected word or phrase.

2. The computing device of claim 1, wherein the selected word or phrase comprises a string of one or more characters or symbols.

3. The computing device of claim 1, wherein the selected word or phrase comprises an equation.

4. The computing device of claim 1, wherein the processor is to present the set of search results by:
displaying a visual representation of each of the one or more e-books.

5. The computing device of claim 1, wherein the processor is to present the set of search results by:
displaying one or more sentences of e-book content from each of the one or more e-books, wherein at least one of the one or more sentences from each e-book contains the selected word or phrase.

6. The computing device of claim 1, wherein the processor is to present the set of search results by:
displaying a paragraph of e-book content from each of the one or more e-books, wherein at least one sentence in each paragraph contains the selected word or phrase.

7. The computing device of claim 1, wherein the processor is to further:
enable a user to purchase the one or more e-books from the set of search results.

8. The computing device of claim 1, wherein the processor is to further:
filter or sort the set of search results by genre, popularity, reviews, or publication date.

9. The computing device of claim 1, wherein the processor is to further:
filter or sort the set of search results based on a number of instances of the selected word or phrase in each of the one or more e-books.

10. The computing device of claim 1, wherein the processor is to further:
filter or sort the set of search results based on a sentence length associated with each instance of the selected word or phrase contained in each of the one or more e-books.

11. A method for operating a computing device, the method being implemented by one or more processors and comprising:
displaying content pertaining to an e-book on a screen of a display assembly of the computing device;
detecting a first user interaction with a set of touch sensors provided with the display assembly;
interpreting the first user interaction as a first user input corresponding with a selection of a word or phrase in the displayed content;
in response to the first user input, searching an e-book library for e-books containing the selected word or phrase; and
presenting a set of search results on the display assembly, wherein the set of search results includes one or more e-books that contain the selected word or phrase.

12. The method of claim 11, wherein the selected word or phrase comprises a string of one or more characters or symbols.

13. The method of claim 11, wherein the selected word or phrase comprises an equation.

14. The method of claim 11, wherein presenting the set of search results comprises:
displaying a visual representation of each of the one or more e-books.

15. The method of claim 11, wherein presenting the set of search results comprises:
displaying one or more sentences of e-book content from each of the one or more e-books, wherein at least one of the one or more sentences from each e-book contains the selected word or phrase.

16. The method of claim 11, wherein presenting the set of search results comprises:
displaying a paragraph of e-book content from each of the one or more e-books, wherein at least one sentence in each paragraph contains the selected word or phrase.

17. The method of claim 11, further comprising:
enabling a user to purchase the one or more e-books from the set of search results.

18. The method of claim 17, further comprising:
filtering or sorting the set of search results based on a number of instances of the selected word or phrase in each of the one or more e-books.

19. The method of claim 17, further comprising:
filtering or sorting the set of search results based on a sentence length associated with each instance of the selected word or phrase contained in each of the one or more e-books.

20. A non-transitory computer-readable medium that stores instructions, that when executed by one or more processors, cause the one or more processors to perform operations that include:
displaying content pertaining to an e-book on a screen of a display assembly of the computing device;
detecting a first user interaction with a set of touch sensors provided with the display assembly;
interpreting the first user interaction as a first user input corresponding with a selection of a word or phrase in the displayed content;
in response to the first user input, searching an e-book library for e-books containing the selected word or phrase; and
presenting a set of search results on the display assembly, wherein the set of search results includes one or more e-books that contain the selected word or phrase.
